(19) United States
(12) Patent Application Publication
(10) Pub. No.: US 2016/0181817 A1
(43) Pub. Date: Jun. 23, 2016

(54) POWER-SOURCE MULTIPLEXING SYSTEM AND POWER-SUPPLIED UNIT

(71) Applicant: MITSUBISHI ELECTRIC CORPORATION, Tokyo (JP)

(72) Inventors: Yoshinobu SHIMIZU, Tokyo (JP); Masatoshi TOYONAGA, Tokyo (JP)

(73) Assignee: Mitsubishi Electric Corporation, Tokyo (JP)

(21) Appl. No.: 14/906,815

(22) PCT Filed: May 8, 2014
(86) PCT No.: PCT/JP2014/062383

§ 371 Date: Jan. 21, 2016

(51) Int. Cl. H02J 5/00

(52) U.S. Cl. CPC H02J 5/00

(57) ABSTRACT

In a power-source multiplexing system that includes redundant power supplies for improving reliability, there is provided a power source unit, a power source unit, and a power-supplied unit to which power is supplied from the power source units and. The power-supplied unit includes a duplex circuit that is a control unit adjusting currents from the power source units. The duplex circuit adjusts a current and outputs the current to a power source line.

### FIELD

The present invention relates to a power-source multiplexing system capable of performing power supply from multiple systems and a power-supplied unit.

### BACKGROUND

To redundantly supply power to electronic devices that require certain reliability, in a conventional programmable logic controller with a dual power supply system (a power-source duplex system), a duplex circuit that adjusts a current in the dual power supply system necessary for the power-source duplex system is mounted on each power source unit to be used in the power-source duplex system. The power source unit on which the duplex circuit mounted serves as a power source unit dedicated to the power-source duplex system (a dedicated power source unit). To distribute the load to be supplied to the system, one dedicated power source unit communicates with the other dedicated power source unit connected to the power-source duplex system, thereby sharing the load.

The duplex circuit includes a current adjusting unit that adjusts currents, which is represented by a matching diode or an FET (Field Effect Transistor) and a controlling unit that controls currents of two duplex power source units. Two dedicated power source units are mounted on a unit (a power-supplied unit) to which power is supplied, represented by a base unit of a programmable logic controller, which is a base unit (a duplex base) dedicated to the power-source duplex system on which two power sources can be mounted, and dual power supply systems are prepared. In this manner, the power source is made redundant for the programmable logic controller. This technique is disclosed in Patent Literature 1 listed below.

### CITATION LIST

### Patent Literature

Patent Literature 1: Japanese Patent Application Laid-open No. 2008-148513, FIG. 1

### SUMMARY

### Technical Problem

However, in the above conventional technique, each of the dedicated power source units mutually monitors the load state of the other dedicated power source unit, and the load is equally distributed to supply power to the power-supplied unit (that is, load sharing). Accordingly, a unit that mutually monitors and performs load sharing needs to be mounted on the side of the dedicated power source unit. To establish the power-source duplex system, it is necessary to develop both dedicated power source units and a power-supplied unit on which two dedicated power source units can be mounted. Thus, there is a problem in that the development cost increases.

The present invention has been made in view of the above, and an object of the present invention is to provide a power-source multiplexing system and a power-supplied unit that can reduce the development cost as compared to conventional systems.

### Solution to Problem

To solve the above problem and achieve an object, there is provided a power-source multiplexing system according to the present invention including: a first power source unit; a second power source unit; and a power-supplied unit to which power is supplied from the first and second power source units. The power-supplied unit includes a control unit that adjusts currents from the first and second power source units.

### Advantageous Effects of Invention

The power-source multiplexing system and the power-supplied unit according to the present invention can reduce the development cost as compared to conventional systems.

### BRIEF DESCRIPTION OF DRAWINGS

FIG. 1 is a diagram illustrating a configuration example of a power-source duplex system according to a first embodiment.

FIG. 2 is a diagram illustrating a configuration example of a duplex circuit according to the first embodiment.

FIG. 3 is a diagram illustrating a configuration example of a power-source multiplex system according to a second embodiment.

FIG. 4 is a diagram illustrating a configuration example of a power-source multiplex system according to a third embodiment.

FIG. 5 is a diagram illustrating a configuration example of a power-source multiplex system according to a fifth embodiment.

FIG. 6 is a diagram illustrating a configuration example of a duplex circuit according to a ninth embodiment.

### DESCRIPTION OF EMBODIMENTS

Exemplary embodiments of a power-source multiplexing system and a power-supplied unit according to the present invention will be explained below in detail with reference to the accompanying drawings. The present invention is not limited to the embodiments.

### First Embodiment

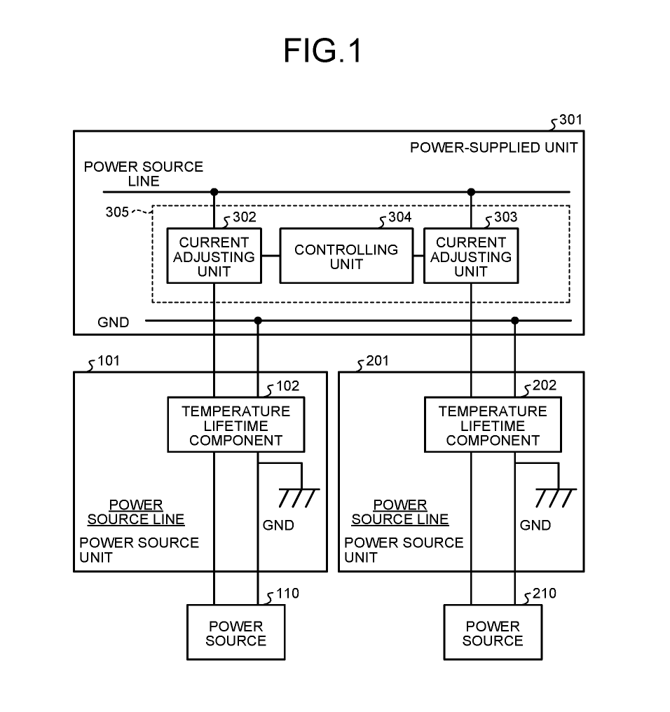

FIG. 1 is a diagram illustrating a configuration example of a power-source duplex system according to a first embodiment of the present invention. The power-source duplex system includes power source units 101 and 201 and a power-supplied unit 301. As an example of a power-source multiplex system, a power-source duplex system having a duplex power source is described.

The power source unit 101 is a power source unit used for the power-source duplex system, and is connected to a power source 110 through a feed line (a power source line, a GND). The power source unit 201 is a power source unit used for the power-source duplex system and is connected to a power source 210 through a feed line (a power source line, a GND). Each of the power source units 101 and 201 has a general configuration and includes an input function section to which a primary power source (an alternating current and a direct current) supplied from outside is input, a primary-side rectifying/smoothing function section that performs rectifiing and smoothing regarding the primary power source, a switching function section that converts rectified currents to high frequencies, a secondary-side rectifying/smoothing function section that performs rectifing and smoothing regarding a secondary power source, and an output function section that outputs power from the secondary power source to the power-supplied unit 301. For example, each of the primary-side rectifying/smoothing function section and the secondary-side rectifying/smoothing function section is configured using a temperature lifetime component formed of, for example, an electrolytic capacitor. In FIG. 1, temperature lifetime components 102 and 202 are mounted on the power source units 101 and 201, respectively. The temperature lifetime components 102 and 202 refer to components whose lifetimes largely depend on (are influenced by) a temperature. More specifically, an example of such components is an electrolytic capacitor as described above.

The power-supplied unit 301 needs to be supplied with power which is secured redundant in the power duplex system. In a case of a programmable logic controller, the power-supplied unit 301 becomes a base unit. The two power source units 101 and 201 are attached to the power-supplied unit 301. The power-supplied unit 301 has mounted thereon current adjusting units 302 and 303 that respectively adjust currents supplied from the power source units 101 and 201 to the power source line of the power-supplied unit 301. Further, the power-supplied unit 301 has mounted thereon a controlling unit 304 that controls the current adjusting units 302 and 303. The current adjusting units 302 and 303 and the controlling unit 304 constitute a duplex circuit 305, which is a control unit.

In a normal operation state of the power-source duplex system, two systems simultaneously operate in such a way that a load is equally distributed to the power source units 101 and 201 under control of the controlling unit 304. When power supply in one of the two systems stops because of a failure in the power source unit 101 or 201 or the stop of one feeding line, the controlling unit 304 detects the stop of power supply and promptly controls the other power supplying system to supply power to the entire power-supplied unit 301. In this way, the power-source duplex system can continue operations of the entire system and the reliability is improved. More specifically, the controlling unit 304 monitors the output voltages of the power source units 101 and 201 and compares the output voltages of the power source units 101 and 201. When the difference between the output voltages exceeds an effective range of load sharing, the controlling unit 304 constantly turns on the current adjusting unit of one of the power source units that outputs a normal voltage and constantly turns off the current adjusting unit of the other power source unit that outputs an abnormal voltage. The load sharing is invalidated in this manner and power is supplied to the power-supplied unit 301 only by the normal power source unit. At this time, the abnormal power source unit is disconnected from the power-source duplex system by a current rectifying unit, and an operation such as replacement of the abnormal power source unit can be taken.

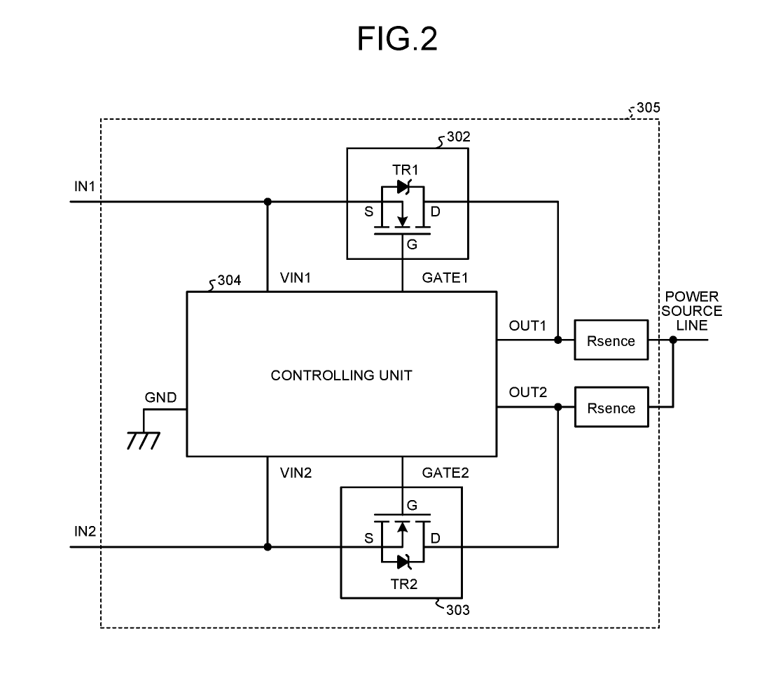

FIG. 2 is a diagram illustrating a configuration example of a duplex circuit according to the present embodiment. The output terminal of the power source unit 101 illustrated in FIG. 1 is connected to a terminal IN1 of the duplex circuit 305 illustrated in FIG. 2, and similarly the output terminal of the power source unit 201 is connected to a terminal IN2 of the duplex circuit 305. The power source line illustrated in FIG. 2 is the power source line in the power-supplied unit 301 illustrated in FIG. 1. The terminals IN1 and IN2 of the duplex circuit 305 are connected to terminals VIN1 and VIN2 of the controlling unit 304, respectively. The controlling unit 304 measures output voltages of the power source units 101 and 201 that are applied to the terminals VIN1 and VIN2, respectively. When a potential difference occurs between the measured terminals VIN1 and VIN2, the controlling unit 304 controls the voltages at gates GATE1 and GATE2 to adjust a forward-voltage drop amount of FETs (TR1 and TR2) in the current adjusting units 302 and 303 until the voltage at the terminal OUT1 becomes equal to that at the terminal OUT2. Accordingly, output currents of the two power source systems are balanced.

It is also possible that the controlling unit 304 controls the voltages at the gates GATE1 and GATE2 so as to make the voltage at the terminal OUT1 equal to that at the terminal OUT2 without measuring the output voltages of the power source units 101 and 201 that are applied respectively to the terminals VIN1 and VIN2, and controls the outputs from the current adjusting units 302 and 303, thereby balancing the output currents of two power source systems.

When a failure or short circuit occurs in the power source unit 101 or the power source unit 201, the controlling unit 304 detects the failure or short circuit and turns off the gate GATE1 or the gate GATE2 quickly. Accordingly, a current is prevented from flowing into the power source system having the failure or short circuit and the system can be protected.

In the power-source duplex system configured as described above, it is not necessary to perform communication required for load sharing in the power source units 101 and 201, and the entire duplex circuit 305 required for the power-source duplex system is mounted on the power-supplied unit 301. Accordingly, a duplex circuit that is conventionally mounted on the side of the power source unit can be omitted. For this reason, dedicated power source units do not need to be used for the power source units 101 and 201 and standard power source units can be used. In establishing a conventional power-source duplex system, it has been necessary to develop dedicated power source units and a power-supplied unit on which two dedicated power source units can be mounted. On the other hand, the development cost can be suppressed in the present embodiment because the power-source duplex system can be realized only by developing the power-supplied unit 301. In addition, users of the power-source duplex system can use standard power source units and thus usage convenience is improved.

The current adjusting units, controlling units, and accompanying resistors, and capacitors, which are mounted on each power source unit in conventional systems, can be integrally mounted as the duplex circuit 305 in the power-supplied unit 301. Therefore, the number of components including the controlling unit 304, accompanying resistors, and capacitors can be reduced, and the product cost can be reduced.

Because the number of components can be reduced, the failure rate of the omitted components can be subtracted from an MTBF (Mean Time Between Failure(s)) value, which is an average failure interval in the power-source duplex system. Therefore, the reliability of the entire system can be improved.

Furthermore, the temperature lifetime components 102 and 202, which are represented by electrolytic capacitors, are mounted on the power source units 101 and 201. The lifetime of the electrolytic capacitor generally follows the following mathematical expression (an Arrhenius rule) that expresses a relation between an electrolytic-capacitor lifetime and a temperature. When an ambient temperature increases by 10° C., an electrolytic-capacitor lifetime is halved.

L=Lo×2^{(Tmax-Ta)/10}

In the above expression, L is a lifetime in actual use (Hr), Lo is a lifetime at a rated temperature (Hr), Tmax is a rated temperature (° C.), and Ta is an ambient temperature (° C.).

Meanwhile, the duplex circuit 305 includes the current adjusting units 302 and 303 mounted thereon. In the conventional system, the current adjusting units are mounted on the side of the power source units, and thus the temperature lifetime components 102 and 202 and the current adjusting units 302 and 303 are included in the same unit, respectively. Accordingly, there is a problem in that the lifetimes of the temperature lifetime components 102 and 202 are decreased due to heat generated from the current adjusting units 302 and 303, respectively. In the present embodiment, the temperature lifetime components 102 and 202 and the current adjusting units 302 and 303 are arranged in different units, and these components are remotely arranged. Accordingly, the lifetimes of the temperature lifetime components 102 and 202 can be prolonged, that is, the lifetime of the power-source duplex system can be prolonged.

Furthermore, the number of components in the duplex circuit 305 is reduced, and measures for heat radiation in the temperature lifetime components 102 and 202 become unnecessary. Accordingly, downsizing of the power-source duplex system can be achieved.

In the above descriptions, the number of the power source systems that supply power to the power-supplied unit 301 is explained as two, but the number is not limited thereto. The number of the power source units and supplying sources to the power source units may be increased, and it is needless to mention that the above descriptions can be also applied to a power-source multiplexing system.

Furthermore, in the above descriptions, it has been explained that, to each of the power source units 101 and 201 that supplies power to the power-supplied unit 301, power is respectively supplied from different supplying sources (power sources), but the present embodiment is not limited thereto. Power can be supplied to each of the power source units 101 and 201 from a same supplying source, and it is needless to mention that the above descriptions can be also applied to a power-source multiplexing system directed to maintain redundancy of power source units.

### Second Embodiment

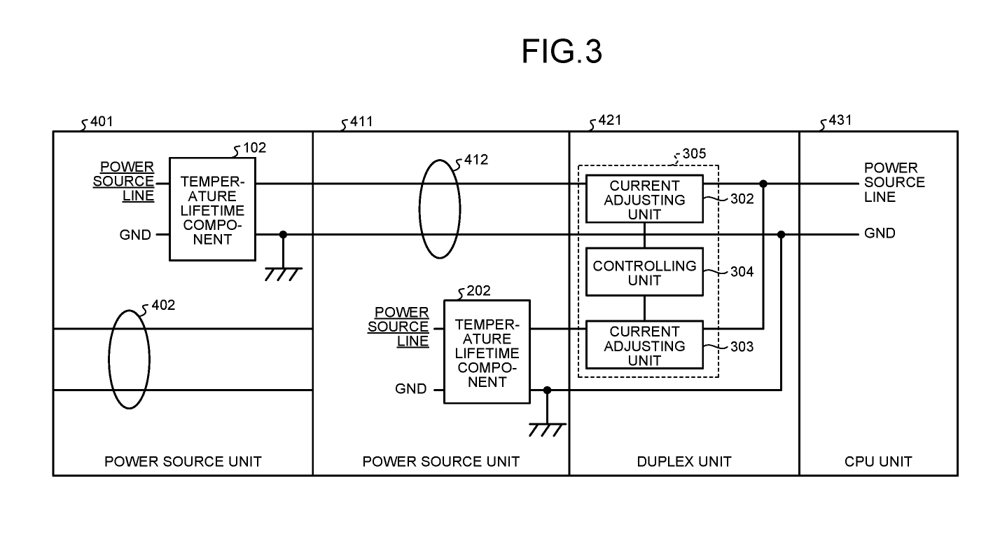

FIG. 3 is a diagram illustrating a configuration example of a power-source multiplexing system according to a second embodiment of the present invention. The power-source duplex system includes power source units 401 and 411, a duplex unit 421, and a CPU (Central Processing Unit) unit 431. The power source unit 401 includes the temperature lifetime component 102 and a power source line 402. The power source unit 411 includes the temperature lifetime component 202 and a power source line 412. Similarly to the power source units 101 and 201, each of the power source units 401 and 411 has an input functionsection, a primary-side rectifying/smoothing functionsection, a switching functionsection, a secondary-side rectifying/smoothing function section, and an output function section. The duplex unit 421 includes the duplex circuit 305 constituted by the current adjusting units 302 and 303 and the controlling unit 304. Constituent elements identical to those of the first embodiment are denoted by same reference signs and descriptions thereof will be omitted.

A power source line of the temperature lifetime component 102 of the power source unit 401 is connected to a power source line of the CPU unit 431 through the power source line 412 of the power source unit 411 and the current adjusting unit 302 of the duplex unit 421. A power source line of the temperature lifetime component 202 of the power source unit 411 is connected to the power source line of the CPU unit 431 through the current adjusting unit 303 of the duplex unit 421. The GND of the temperature lifetime component 102 of the power source unit 401 is connected to the GND of the CPU unit 431 through the power source line 412 of the power source unit 411 and the duplex unit 421. The GND of the temperature lifetime component 202 of the power source unit 411 is connected to the GND of the CPU unit 431 through the duplex unit 421.

In the first embodiment, the components of the duplex circuit 305 are mounted on the power-supplied unit 301 that is assumed as a base unit of a programmable logic controller. However, even when the components of the duplex circuit 305 are mounted in other configurations, equivalent effects can be achieved.

For example, as illustrated in FIG. 3, when a programmable logic controller does not include a base unit, instead of developing a duplex base unit, the duplex unit 421 that includes the duplex circuit 305 and the dedicated power source units 401 and 411 that respectively include the power source lines 402 and 412, which transfer power from another power source unit to the duplex unit 421, are developed. In such a case, similarly to the first embodiment, the production cost of the power-source duplex system can be reduced due to the reduction in the number of the components, the reliability can be improved, the lifetime can be prolonged, and downsizing can be achieved.

### Third Embodiment.

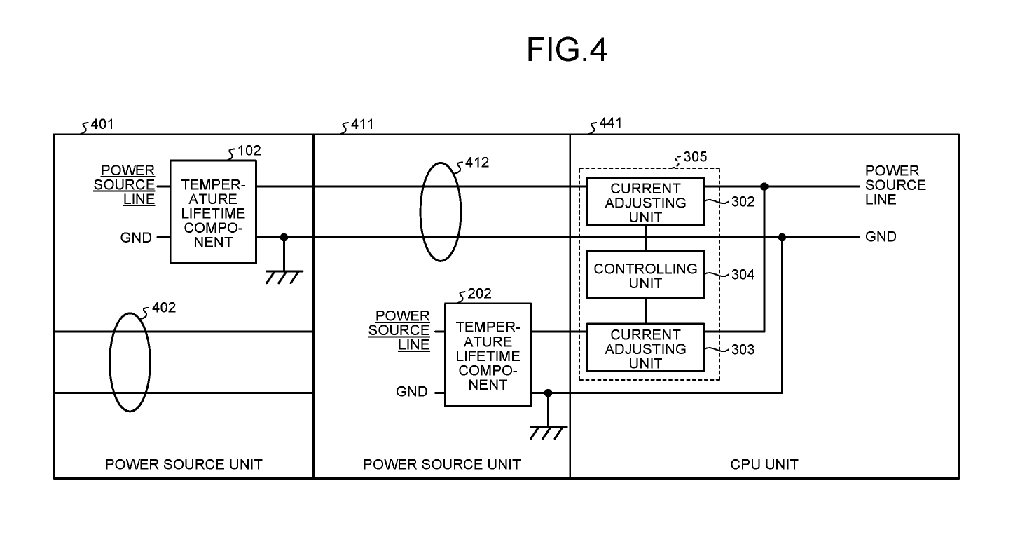

FIG. 4 is a diagram illustrating a configuration example of a power-source multiplexing system according to a third embodiment of the present invention. A power-source duplex system according to the present embodiment includes the power source units 401 and 411 and a CPU unit 441. The CPU unit 441 includes the duplex circuit 305 constituted by the current adjusting units 302 and 303 and the controlling unit 304.

The CPU unit 441 is a unit in which the duplex unit 421 and the CPU unit 431 according to the second embodiment are integrated as one component. However, the connecting relation between respective units is identical to that in the second embodiment. Even when the duplex circuit 305 described in the second embodiment is mounted on the CPU unit 441, similarly to the first embodiment, the production cost of the power-source duplex system can be reduced due to the reduction in the number of components, the reliability can be improved, the lifetime can be prolonged, and downsizing can be achieved.

### Fourth Embodiment

When it is assumed that a power-source duplex system is used on a motherboard of a server system or the like other than being used as a programmable logic controller, effects equivalent to those in the first embodiment can be achieved by mounting the components of the duplex circuit on the motherboard.

### Fifth Embodiment

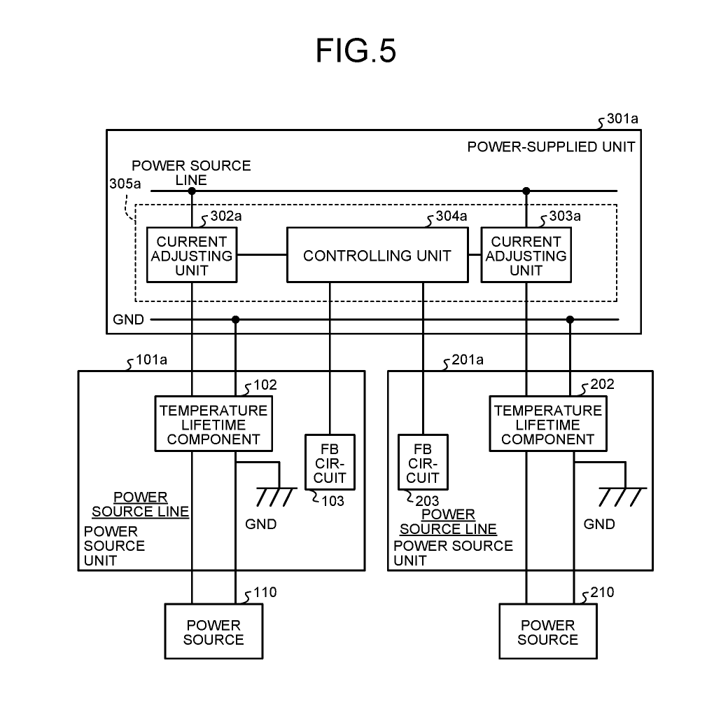

FIG. 5 is a diagram illustrating a configuration example of a power-source multiplexing system according to a fifth embodiment of the present invention. The power-source duplex system includes power source units 101a and 201a and a power-supplied unit 301a. The power source units 101a and 201a include the temperature lifetime components 102 and 202 and feedback circuits 103 and 203, respectively. The power-supplied unit 301a includes a duplex circuit 305a constituted by current adjusting units 302a and 303a and a controlling unit 304a. The present embodiment differs from the first embodiment in that the power source units 101a and 201a include the feedback circuits 103 and 203, respectively, and the controlling unit 304a is connected to the feedback circuits 103 and 203. The connecting relations among the power sources 110 and 210, the temperature lifetime components 102 and 202, and the current adjusting units 302a and 303a are identical to those in the first embodiment. Similarly to the power source units 101 and 201, each of the power source units 101a and 201a has an input function section, a primary-side rectifying/smoothing function section, a switching function section, a secondary-side rectifying/smoothing function section, and an output function section.

In the present embodiment, the controlling unit 304a monitors the output voltages of the power source units 101a and 201a and compares the output voltages of the power source units 101a and 201a. When the difference between the output voltages exceeds the effective range of load sharing, the controlling unit 304a transfers a signal for controlling the load to the feedback circuits 103 and 203 of the power source units 101a and 201a, respectively. In the power source units 101a and 201a, the outputs from the temperature lifetime components 102 and 202 are controlled by the feedback circuits 103 and 203, respectively. While FETs are used for the current adjusting units 302 and 303 in the first embodiment, in the present embodiment, as illustrated in FIG. 5, conventional matching diodes can be used as the current adjusting units 302a and 303a.

Due to this configuration, the temperature lifetime components 102 and 202 of the power source units 101a and 201a and the current adjusting units 302a and 303a, which are heating components, can be arranged in respectively different units. Therefore, the lifetime of the system can be prolonged, and downsizing can be achieved because measures for heat radiation are not necessary.

### Sixth Embodiment

In the first embodiment, two systems of power source units and supplying sources to the power source units are prepared. However, as more than two power source systems are prepared, it becomes possible to obtain higher reliability as a power-source multiplexing system.

### Seventh Embodiment

In the first embodiment, in the power-source duplex system, all the components of the duplex circuit 305 are mounted on the power-supplied unit 301, which is a base unit. However, it is also possible that some of the components of the duplex circuit 305 are mounted on the power source units 101 and 201.

For example, a case is considered where the controlling unit 304 is mounted on each of the power source units 101 and 201. In this case, reduction in the product cost due to reduction in the number of components of the controlling unit 304 itself, improved reliability, and reduction in the development cost due to the use of a standard power source cannot be expected. However, the lifetime of the system can be prolonged because the temperature lifetime components 102 and 202 of the power source units 101 and 201 and the current adjusting units 302 and 303, which are heat generating components, are arranged in respectively different units, and downsizing can be achieved because measures for heat radiation is unnecessary.

### Eighth Embodiment

In contrast to the seventh embodiment, a case is considered where the current adjusting units 302 and 303 are respectively mounted on the power source units 101 and 201, and the controlling unit 304 is mounted on the power-supplied unit 301, which is a base unit. In this case, reduction in the development cost due to the use of a standard power source, prolongation of the lifetime due to remote-positioning of temperature lifetime components and heating components, and downsizing of the system cannot be expected in a power-source duplex system. However, because the integration of components around the controlling unit reduces the number of components, the product cost can be reduced, the reliability can be improved, and downsizing can be achieved due to reduction in the mounting area.

### Ninth Embodiment

In a power-source duplex system, a duplex circuit itself can be redundant in the power-supplied unit 301.

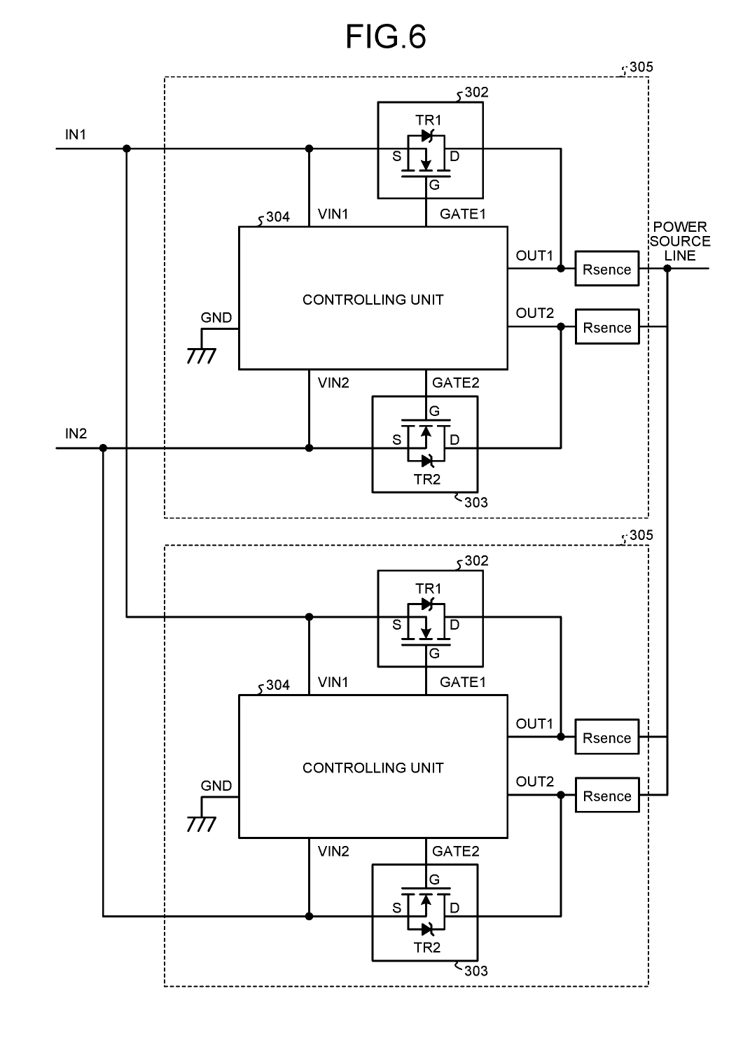

FIG. 6 is a diagram illustrating a configuration example of a duplex circuit according to a ninth embodiment of the present invention. Terminals to which IN1 and IN2 are connected and power source lines illustrated in FIG. 6 are identical to those in FIG. 2 (described in the first embodiment). In this example, the power-supplied unit 301 has two duplex circuits 305, and the current adjusting units 302 and 303 of the respective power source systems and the controlling unit 304 are duplex, and thus, even when the duplex circuit 305 in one system has a failure, power supply can be continued with the duplex circuit 305 in the other system, thereby achieving an effect of improving the reliability of the entire system.

### Tenth Embodiment

In the first to ninth embodiments described above, a power-source duplex system that has two power source systems with two power source units has been specifically described. However, the power-source duplex system described above is only an example and the number of power source systems is not limited to two. For example, the embodiments described above can be also applied to a power-source triplex system having three power source systems, and can be also applied to a power-source multiplexing system having four or more power source systems.

### INDUSTRIAL APPLICABILITY

As described above, the power-source multiplexing system according to the present invention is useful as a power-source supplying system of an electronic device that requires high reliability, and is particularly suitable for a power-source duplex system of a programmable logic computer, a server system, and the like.

### REFERENCE SIGNS LIST

101, 101a, 201, 201a, 401, 411 power source unit, 102, 202 temperature lifetime component, 103, 203 feedback circuit, 110, 210 power source, 301, 301a power-supplied unit, 302, 302a, 303, 303a current adjusting unit, 304, 304a controlling unit, 305, 305a duplex circuit, 402, 412 power source line, 421 duplex unit, 431, 441 CPU unit.

1. A power-source multiplexing system comprising:
a first power source unit;
a second power source unit; and
a power-supplied unit to which power is supplied from the first and second power source units, wherein
the power-supplied unit includes a control unit to adjust currents from the first and second power source units.

2. A power-source multiplexing system comprising:
a plurality of power source units; and
a power-supplied unit to which power is supplied from the plurality of power source units, wherein
the power-supplied unit includes a control unit to adjust currents from the plurality of power source units.

3. A power-source multiplexing system comprising
a power-supplied unit to which power is supplied from a power source unit, wherein
the power-supplied unit includes a control unit to adjust a current from the power source unit.

4. The power-source multiplexing system according to claim 1, wherein
the control unit includes
a controlling unit to measure power supplied from the power source unit, and
a current adjusting unit to adjust a current from the power source unit based on control by the controlling unit, and
the controlling unit is arranged in the power source unit, and the current adjusting unit is arranged in the power-supplied unit.

5. The power-source multiplexing system according to claim 1, wherein
the control unit includes
a controlling unit to measure power supplied from the power source unit, and
a current adjusting unit to adjust a current from the power source unit based on control by the controlling unit, and
the controlling unit is arranged in the power-supplied unit, and the current adjusting unit is arranged in the power source unit.

6. The power-source multiplexing system according to claim 1, wherein the power-supplied unit includes two or more control units.

7. The power-source multiplexing system according to claim 1, wherein, among circuit components to supply power to the power-supplied unit, a temperature lifetime component whose component lifetime is influenced by an ambient temperature is included in the power source unit.

8. The power-source multiplexing system according to claim 1, wherein the control unit adjusts a current from the power source unit by use of an FET.

9. The power-source multiplexing system according to claim 1, wherein the power source unit does not include a circuit to adjust a current when power is supplied to the power-supplied unit.

10. A power-supplied unit to which power is supplied from a first power source unit and a second power source unit, the power-supplied unit comprising
a control unit to adjust respective currents from the first and second power source units.

11. A power-supplied unit to which power is supplied from a plurality of power source units, the power-supplied unit comprising
a control unit to adjust currents from the plurality of power source units.

12. A power-supplied unit to which power is supplied from a power source unit, the power-supplied unit comprising
a control unit to adjust a current from the power source unit.

13. The power-supplied unit according to claim 10, wherein
the control unit includes
a controlling unit to measure power supplied from the power source unit, and
a current adjusting unit to adjust a current from the power source unit based on control by the controlling unit, and
the controlling unit is arranged in the power source unit, and the current adjusting unit is arranged in the power-supplied unit.

14. The power-supplied unit according to claim 10, wherein
the control unit includes
a controlling unit to measure power supplied from the power source unit, and
a current adjusting unit to adjust a current from the power source unit based on control by the controlling unit, and
the controlling unit is arranged in the power-supplied unit, and the current adjusting unit is arranged in the power source unit.

15. The power-supplied unit according to claim 10, wherein the power-supplied unit includes two or more control units.

16. The power-supplied unit according to claim 10, wherein the power-supplied unit is connected to a power source unit that includes a temperature lifetime component, among circuit components that supply power to the power-supplied unit, whose component lifetime is influenced by an ambient temperature.

17. The power-supplied unit according to claim 10, wherein the control unit adjusts a current from the power source unit by use of an FET.

18. The power-supplied unit according to claim 10, wherein the power-supplied unit is connected to the power source unit that does not include a circuit to adjust a current when power is supplied to the power-supplied unit.

19. The power-source multiplexing system according to claim 2, wherein
the control unit includes
a controlling unit to measure power supplied from the power source unit, and
a current adjusting unit to adjust a current from the power source unit based on control by the controlling unit, and
the controlling unit is arranged in the power source unit, and the current adjusting unit is arranged in the power-supplied unit.

20. The power-source multiplexing system according to claim 2, wherein
the control unit includes
a controlling unit to measure power supplied from the power source unit, and
a current adjusting unit to adjust a current from the power source unit based on control by the controlling unit, and
the controlling unit is arranged in the power-supplied unit, and the current adjusting unit is arranged in the power source unit.

21. The power-source multiplexing system according to claim 2, wherein the power-supplied unit includes two or more control units.

22. The power-source multiplexing system according to claim 2, wherein, among circuit components to supply power to the power-supplied unit, a temperature lifetime component whose component lifetime is influenced by an ambient temperature is included in the power source unit.

23. The power-source multiplexing system according to claim 2, wherein the control unit adjusts a current from the power source unit by use of an FET.

24. The power-source multiplexing system according to claim 2, wherein the power source unit does not include a circuit that adjusts a current when power is supplied to the power-supplied unit.

25. The power-source multiplexing system according to claim 3, wherein
the control unit includes
a controlling unit to measure power supplied from the power source unit, and
a current adjusting unit to adjust a current from the power source unit based on control by the controlling unit, and
the controlling unit is arranged in the power source unit, and the current adjusting unit is arranged in the power-supplied unit.

26. The power-source multiplexing system according to claim 3, wherein
the control unit includes
a controlling unit to measure power supplied from the power source unit, and
a current adjusting unit to adjust a current from the power source unit based on control by the controlling unit, and
the controlling unit is arranged in the power-supplied unit, and the current adjusting unit is arranged in the power source unit.

27. The power-source multiplexing system according to claim 3, wherein the power-supplied unit includes two or more control units.

28. The power-source multiplexing system according to claim 3, wherein, among circuit components to supply power to the power-supplied unit, a temperature lifetime component whose component lifetime is influenced by an ambient temperature is included in the power source unit.

29. The power-source multiplexing system according to claim 3, wherein the control unit adjusts a current from the power source unit by use of an FET.

30. The power-source multiplexing system according to claim 3, wherein the power source unit does not include a circuit that adjusts a current when power is supplied to the power-supplied unit.

31. The power-supplied unit according to claim 11, wherein
the control unit includes
a controlling unit to measure power supplied from the power source unit, and
a current adjusting unit to adjust a current from the power source unit based on control by the controlling unit, and
the controlling unit is arranged in the power source unit, and the current adjusting unit is arranged in the power-supplied unit.

32. The power-supplied unit according to claim 11, wherein
the control unit includes
a controlling unit to measure power supplied from the power source unit, and
a current adjusting unit to adjust a current from the power source unit based on control by the controlling unit, and
the controlling unit is arranged in the power-supplied unit, and the current adjusting unit is arranged in the power source unit.

33. The power-supplied unit according to claim 11, wherein the power-supplied unit includes two or more control units.

34. The power-supplied unit according to claim 11, wherein the power-supplied unit is connected to a power source unit that includes a temperature lifetime component, among circuit components to supply power to the power-supplied unit, whose component lifetime is influenced by an ambient temperature.

35. The power-supplied unit according to claim 11, wherein the control unit adjusts a current from the power source unit by use of an FET.

36. The power-supplied unit according to claim 11, wherein the power-supplied unit is connected to the power source unit that does not include a circuit that adjusts a current when power is supplied to the power-supplied unit.

37. The power-supplied unit according to claim 12, wherein
the control unit includes
a controlling unit to measure power supplied from the power source unit, and
a current adjusting unit to adjust a current from the power source unit based on control by the controlling unit, and
the controlling unit is arranged in the power source unit, and the current adjusting unit is arranged in the power-supplied unit.

38. The power-supplied unit according to claim 12, wherein
the control unit includes
a controlling unit to measure power supplied from the power source unit, and
a current adjusting unit to adjust a current from the power source unit based on control by the controlling unit, and
the controlling unit is arranged in the power-supplied unit, and the current adjusting unit is arranged in the power source unit.

39. The power-supplied unit according to claim 12, wherein the power-supplied unit includes two or more control units.

40. The power-supplied unit according to claim 12, wherein the power-supplied unit is connected to a power source unit that includes a temperature lifetime component, among circuit components to supply power to the power-supplied unit, whose component lifetime is influenced by an ambient temperature.

41. The power-supplied unit according to claim 12, wherein the control unit adjusts a current from the power source unit by use of an FET.

42. The power-supplied unit according to claim 12, wherein the power-supplied unit is connected to the power source unit that does not include a circuit that adjusts a current when power is supplied to the power-supplied unit.
